(19) United States
(12) Patent Application Publication
(10) Pub. No.: US 2026/0034982 A1
(43) Pub. Date: Feb. 5, 2026

(54) DRIVING ASSISTANCE DEVICE

(71) Applicant: TOYOTA JIDOSHA KABUSHIKI KAISHA, Aichi (JP)

(72) Inventor: Hikaru AKIMOTO, Mishima-shi (JP)

(21) Appl. No.: 19/266,173

(22) Filed: Jul. 11, 2025

(30) Foreign Application Priority Data
Aug. 5, 2024 (JP) 2024-128863

(51) Int. Cl. B60W 30/09; B60W 30/095

(52) U.S. Cl. CPC B60W 30/09; B60W 30/0956; B60W 2420/403; B60W 2420/408; B60W 2520/06; B60W 2554/4029; B60W 2554/801; B60W 2554/802; B60W 2554/803; B60W 2554/804

(57) ABSTRACT

A driving assistance device includes a processor that sequentially acquires information from a first and a second sensor. When both sensors detect the same pedestrian, a counter is incremented. If the counter reaches a threshold and a high risk of contact between the own vehicle and the pedestrian is determined, the processor executes risk reduction control. The threshold value varies depending on the pedestrian's lateral acceleration: if the lateral acceleration is equal to or below a predetermined value, a higher threshold is used; if it exceeds the predetermined value, a lower threshold is applied.

### BACKGROUND

The present invention relates to a driving assistance device that controls an own vehicle so as to reduce the risk of contact between a pedestrian crossing the area in front of the own vehicle and the own vehicle.

### RELATED ART

Devices that determine the presence or absence of a pedestrian located within a detection area in front of an own vehicle have been proposed (see, for example, Patent Document 1 below). This device (hereinafter referred to as the “conventional device”) is provided with a stereo camera. The stereo camera captures image data of a detection area (field of view) in front of the own vehicle. The conventional device includes a first determination unit and a second determination unit that determine the presence or absence of a pedestrian based on the image data.

The first determination unit acquires the dimensions (vertical and horizontal dimensions) of each object in the detection area based on the image data. The first determination unit also acquires the speed of each object based on the time-series image data. Then, the first determination unit determines whether a first condition related to the dimensions and speed of each object (a condition for determining that the object is a pedestrian) is satisfied, and obtains the result as a first determination result.

The second determination unit acquires the motion pattern of each object based on the time-series image data, and determines whether a second condition (a condition for determining that the object is a pedestrian) is satisfied based on the degree of matching between the motion pattern and a predefined pattern (a pattern determined by machine learning that represents pedestrian movement), and obtains the result as a second determination result. The conventional device obtains a final determination result (hereinafter referred to as the “final determination result”) regarding the presence or absence of a pedestrian in the detection area based on a combination of the first and second determination results. This final determination result is provided to a driving assistance device (notification device, braking device, etc.).

The driving assistance device, when obtaining a final determination result indicating the presence of a pedestrian in the detection area, controls a predetermined device of the own vehicle so that the risk of contact between the pedestrian and the own vehicle is reduced. Hereinafter, this control is referred to as “risk reduction control”.

### PRIOR ART DOCUMENTS

[Patent Document 1] Japanese Patent Application Laid-Open No. 2008-310440

### SUMMARY

Meanwhile, a scene in which a pedestrian crosses the area in front of the own vehicle (an area predicted to be passed through by the own vehicle) despite being in close proximity to the own vehicle (i.e., the longitudinal distance between them is relatively small) is conceivable (hereinafter referred to as a “dart-out scene”). In this case, it is desirable that control (risk reduction control) for reducing the risk of contact between the pedestrian and the own vehicle be started as early as possible.

The conventional device obtains a final determination result based on the combination of the first and second determination results, which ensures high determination accuracy, but it takes a relatively long time to obtain the final determination result, and this time is approximately constant. That is, even in an urgent dart-out scene, the conventional device cannot shorten the time from image acquisition to the acquisition of the final determination result. Therefore, in a dart-out scene, there is a risk that the own vehicle and the pedestrian will come very close before the final determination result is obtained.

In other words, there is a risk that the timing of starting the risk reduction control is delayed, making it difficult to efficiently reduce the risk of contact between the own vehicle and the pedestrian.

One of the objects of the present invention is to provide a driving assistance device capable of efficiently reducing the risk of contact between a pedestrian and an own vehicle in a scene where the pedestrian crosses the area in front of the own vehicle.

To achieve the above object, a driving assistance device (1) according to the present invention comprises:
a first sensor (21) and a second sensor (22), which, when detecting a pedestrian located within a predetermined detection area (FOV) in front of the own vehicle, respectively output information (F1, X1, Y1, F2, X2, Y2, spr) regarding the pedestrian; and
a processor (10),
which is configured to sequentially acquire the information from the first sensor and the second sensor,
and, each time the information is acquired, is configured to increment a predetermined counter (CNT) when a condition for determining that the first sensor and the second sensor are detecting the same pedestrian (P) is satisfied,
and further,
when the count value reaches a threshold (CVth) and a condition for determining that there is a high risk of contact between the own vehicle and the pedestrian is satisfied, is configured to execute risk reduction control to control a predetermined device mounted on the own vehicle so that the risk of contact is reduced.

The processor:
executes a first process in which, when it is determined based on the information that the lateral acceleration (αy) of the pedestrian (P) is equal to or less than a predetermined value (αyth), a first count value (N0) is assigned as the threshold of the counter; and
executes a second process in which, when it is determined based on the information that the lateral acceleration of the pedestrian exceeds the predetermined value, a second count value (N1) smaller than the first count value is assigned as the threshold of the counter.

In the driving assistance device according to the present invention, the processor increments the count value of the predetermined counter when it is determined that the same pedestrian is detected by the first and second sensors. Then, the processor makes a final determination (confirmation) that a pedestrian is present in the detection areas of both sensors when the count value reaches the threshold.

Here, when the lateral acceleration of a pedestrian near the own vehicle (within the detection areas of the first and second sensors) is relatively large, the possibility that the pedestrian will cross the area in front of the own vehicle (i.e., dart out into the front area) is high.

Therefore, in the driving assistance device according to the present invention, the processor assigns a relatively small value as the threshold of the counter when the lateral acceleration of a pedestrian (an object that may be finally determined as a pedestrian) exceeds the threshold.

In other words, when the pedestrians detected respectively by the first and second sensors are the same and their lateral acceleration is relatively large, the condition for making a final determination (confirmation) that a pedestrian is present in the detection area is relaxed. That is, the timing for making the final determination that a pedestrian is present in the detection area is advanced.

Then, the processor starts the risk reduction control when the risk of contact between the pedestrian and the own vehicle is high.

Accordingly, the driving assistance device according to the present invention can efficiently reduce the risk of contact between the pedestrian and the own vehicle in a scene where the pedestrian crosses the area in front of the own vehicle.

In one embodiment of the driving assistance device according to the present invention, the processor is capable of executing the second process when the pedestrian and the own vehicle are traveling in the same direction, and the lateral distance (Y2) between the own vehicle and the pedestrian is equal to or less than a threshold (Y2th).

According to this configuration, in a case where the own vehicle and the pedestrian are traveling side by side and the pedestrian crosses the area in front of the own vehicle, the risk of contact between the own vehicle and the pedestrian can be efficiently reduced.

In another embodiment of the driving assistance device according to the present invention, the processor initializes the count value when the condition for determining that the first sensor and the second sensor are detecting the same pedestrian is not satisfied.

In the present embodiment, the processor of the driving assistance device makes a final determination (confirmation) that a pedestrian is present in the detection area only when the state in which the first sensor and the second sensor are detecting the same pedestrian continues for a certain period (i.e., a state in which the count value increases each time information is acquired from the first and second sensors continues). According to this, the detection accuracy for pedestrians is improved.

In another embodiment of the driving assistance device according to the present invention, the first sensor is a camera (21) that detects a pedestrian based on image data obtained by capturing the detection area, and
the second sensor is a radar (22) that detects a pedestrian by radiating radio waves or laser light into the detection area and based on the distribution of the reflection points.

In this embodiment, the processor of the driving assistance device determines whether the pedestrian detected based on the image and the pedestrian detected based on the distribution of reflection points of radio waves or laser light are the same. According to this, compared with a driving assistance device such as in Patent Document 1 that determines the presence or absence of a pedestrian based solely on information obtained from images, the accuracy of pedestrian determination is improved.

In another embodiment of the driving assistance device according to the present invention, the processor acquires the relative speed in the longitudinal direction (spr_x) and the relative speed in the lateral direction (spr_y) between the pedestrian and the own vehicle, and the distance in the longitudinal direction (X2) and the distance in the lateral direction (Y2) between the pedestrian and the own vehicle, and determines that the risk of contact between the pedestrian and the own vehicle is high when the difference (ATTC) between a first time (TTCx) obtained by dividing the longitudinal distance by the longitudinal relative speed and a second time (TTCy) obtained by dividing the lateral distance by the lateral relative speed is equal to or less than a threshold (ΔTTCth), and the first time and the second time are both equal to or less than a threshold (TTCth).

According to this, whether the risk of contact between the own vehicle and the pedestrian is high (i.e., whether there is a high possibility of crossing paths) can be determined relatively easily.

### BRIEF DESCRIPTION OF THE DRAWINGS

FIG. 1 is a block diagram of a driving assistance device according to an embodiment of the present invention.

FIG. 2 is a plan view showing the information acquired by the camera.

FIG. 3 is a plan view showing the information acquired by the millimeter wave radar and the vehicle speed sensor, and the information calculated based on those.

FIG. 4 is a flowchart of a program executed by the CPU to realize the function of executing the risk reduction control.

### DESCRIPTION OF THE EMBODIMENTS

### (Outline)

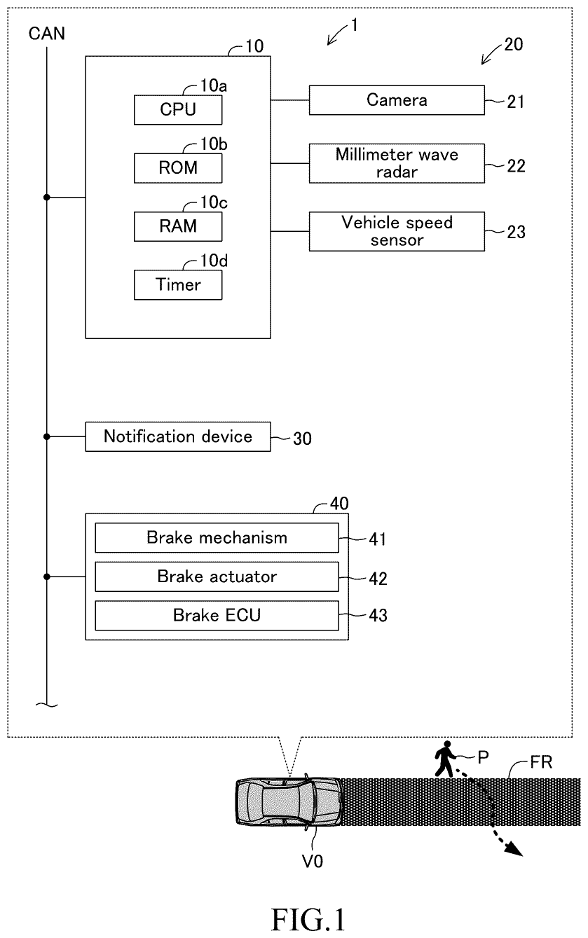

A driving assistance device 1 according to an embodiment of the present invention is applied to a vehicle V0 equipped with an autonomous driving function (hereinafter referred to as the “own vehicle”) (see FIG. 1). The driving assistance device 1 has a risk reduction function that, when the autonomous driving function is disabled, executes risk reduction control to control the own vehicle (notification device 30 and braking device 40) so that the risk of contact with a pedestrian (a pedestrian or bicycle) crossing the area in front (FR) of the own vehicle is reduced.

### (Specific Configuration)

As shown in FIG. 1, the driving assistance device 1 includes an ECU 10, an onboard sensor 20, a notification device 30, and a braking device 40.

The ECU 10 includes a microcomputer comprising a CPU 10a, a ROM 10b (rewritable non-volatile memory), a RAM 10c, a timer 10d, and the like. The CPU executes programs (instructions) stored in the ROM to realize various functions. The ECU 10 is connected to other ECUs via a CAN (Controller Area Network).

The onboard sensor 20 includes a pedestrian detection sensor for detecting a pedestrian P located within a predetermined area in front of the own vehicle. This pedestrian detection sensor is composed of a camera 21 and a millimeter wave radar 22.

The camera 21 (a monocular camera) includes an imaging device and an image analysis device. The imaging device includes, for example, a built-in CCD. It is installed at the front of the own vehicle (for example, in the front grille) and is oriented toward the front of the own vehicle. The imaging device captures the predetermined area (field of view) in front of the own vehicle at a predetermined frame rate to acquire image data.

The image analysis device acquires the image data from the imaging device and analyzes the image data to detect a pedestrian P1 (a pedestrian or a bicycle). That is, the image analysis device identifies the image of the pedestrian P1 in the acquired image from other images.

When the image analysis device detects the pedestrian P1 (i.e., determines that the pedestrian P1 is present), it sets a flag F1 indicating the presence of the pedestrian P1 to “1”. On the other hand, if the pedestrian P1 is not detected, it sets the flag F1 to “0”. The image analysis device provides this detection result (the flag F1 indicating the presence of the pedestrian P1) to the ECU 10 as first pedestrian information.

When the pedestrian P1 is detected, the image analysis device calculates the longitudinal distance X1 between the own vehicle (front end) and the pedestrian P1. It also calculates the lateral distance Y1 between the own vehicle (side) and the pedestrian P1. If the pedestrian P1 is located diagonally in front to the right of the own vehicle, the image analysis device calculates the lateral distance Y1 between the right side of the own vehicle and the pedestrian P1. If the pedestrian P1 is located diagonally in front to the left of the own vehicle, the device calculates the lateral distance Y1 between the left side of the own vehicle and the pedestrian P1.

Based on the position and size of the pedestrian P1 (image) within the field of view, the image analysis device can acquire (estimate) the longitudinal distance X1 and the lateral distance Y1.

Then, the image analysis device provides, in addition to the flag F1, the longitudinal distance X1 and the lateral distance Y1 to the ECU 10 as the first pedestrian information. Note that in this embodiment, a monocular camera is used as one of the pedestrian sensors, but a stereo camera may be used instead.

The millimeter wave radar 22 includes a transmission/reception unit and a signal processing unit. The transmission/reception unit radiates millimeter wave band radio waves (hereinafter referred to as “millimeter waves”) into a predetermined area in front of the own vehicle, and receives millimeter waves (reflected waves) reflected by objects located within the area.

The signal processing unit acquires various kinds of information about each reflection point of the millimeter waves based on physical quantities such as the time from the transmission of the millimeter wave to the reception of the reflected wave, the attenuation level of the reflected wave, and the difference between the frequency of the transmitted millimeter wave and that of the received reflected wave.

For example, the signal processing unit calculates the position of each reflection point (relative position to the transmission/reception unit in terms of direction and distance). Based on the distribution pattern of the reflection points, the signal processing unit detects a pedestrian P2.

When the pedestrian P2 is detected (i.e., when it is determined that the pedestrian P2 is present), the signal processing unit sets a flag F2 indicating the presence of the pedestrian P2 to “1”. If the pedestrian P2 is not detected, it sets the flag F2 to “0”.

The signal processing unit provides this detection result (the flag F2 indicating the presence of the pedestrian P2) to the ECU 10 as second pedestrian information.

Furthermore, when the pedestrian P2 is detected, the signal processing unit calculates the longitudinal distance X2 between the own vehicle (front end) and the pedestrian P2 based on the information obtained from the transmission/reception unit. It also calculates the lateral distance Y2 between the own vehicle (side) and the pedestrian P2.

If the pedestrian P2 is located diagonally in front to the right of the own vehicle, the signal processing unit calculates the lateral distance Y2 between the right side of the own vehicle and the pedestrian P2. If the pedestrian P2 is located diagonally in front to the left, it calculates the lateral distance Y2 between the left side of the own vehicle and the pedestrian P2.

Additionally, the signal processing unit calculates the relative speed spr of the pedestrian P2 with respect to the own vehicle.

Then, in addition to the flag F2, the signal processing unit provides the longitudinal distance X2, the lateral distance Y2, and the relative speed spr to the ECU 10 as the second pedestrian information.

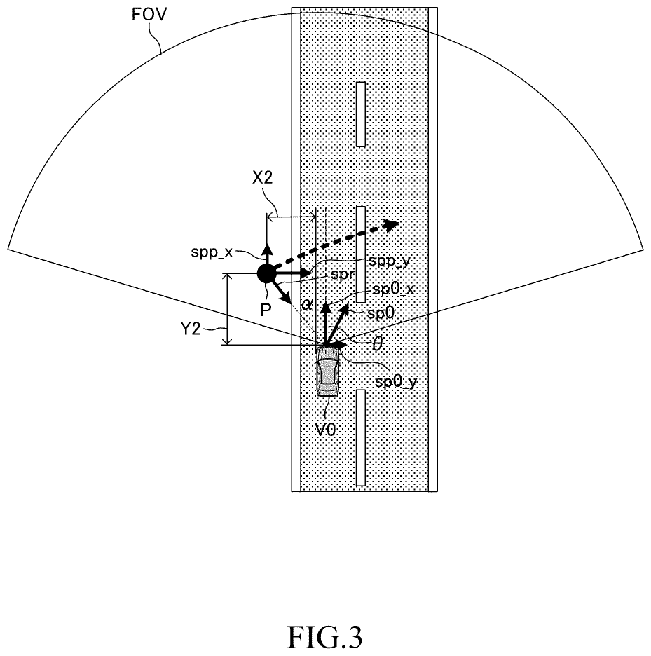

FIG. 3 shows a situation in which the distance between the own vehicle and the pedestrian P2 is decreasing (i.e., the two are approaching each other).

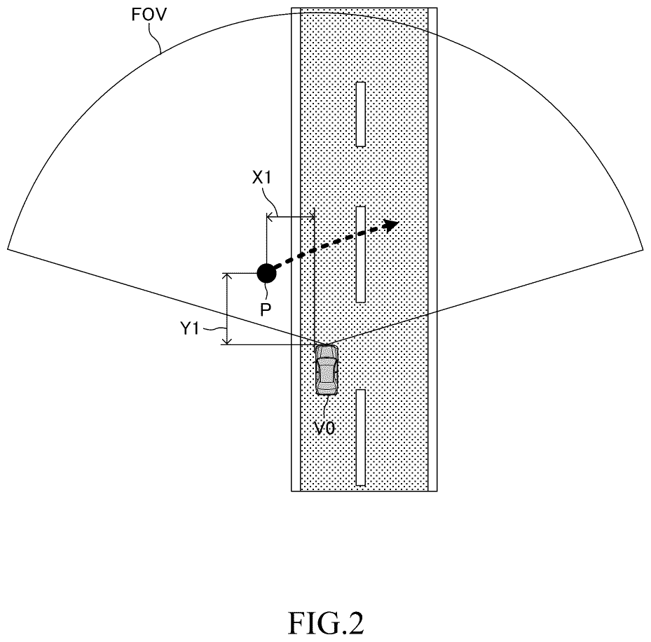

Here, in a plan view, the field of view (image-capturable range) of the camera 21 and the field of view (area where millimeter waves are radiated) of the millimeter wave radar 22 overlap. In the following description, the overlapping area of both is referred to as the “detection area FOV.” As shown in FIGS. 2 and 3, in a plan view, the detection area FOV has a fan shape.

The onboard sensor 20 further includes a vehicle speed sensor 23. The vehicle speed sensor 23 includes a rotation count measurement circuit and a vehicle speed computation device. The rotation count measurement circuit includes a pulse generation circuit that outputs a pulse (electric signal) each time a wheel of the own vehicle rotates by a predetermined angle, and a counter circuit that counts the number of such pulses. The vehicle speed computation device acquires the output value (pulse count) of the counter circuit at a predetermined cycle (each elapsed unit time) and resets the count value to “0.” In this manner, the vehicle speed computation device acquires the number of wheel rotations per unit time.

The vehicle speed computation device acquires the vehicle speed sp0 of the own vehicle by multiplying the wheel rotation count by a predetermined coefficient (see FIG. 3). Then, the vehicle speed computation device provides the obtained vehicle speed sp0 to the ECU 10.

The ECU 10 obtains the steering angle θ of the own vehicle from a steering device (not shown). Based on the vehicle speed sp0 and the steering angle θ, the ECU 10 calculates the longitudinal velocity sp0_x (=sp0·cos θ) and lateral velocity sp0_y (=sp0·sin θ) of the own vehicle.

Moreover, based on the angle α (=ArcTan(X2/Y2)), the relative speed spr, and the longitudinal velocity sp0_x and lateral velocity sp0_y, the ECU 10 calculates the pedestrian's longitudinal velocity spp_x (=sp0_x−spr·sin α) and lateral velocity spp_y (=spr·cos α+sp0_y).

The notification device 30 includes a display device and an audio device. The display device is disposed, for example, on the instrument panel (such as near the speedometer). The display device receives a display command from the ECU 10 and displays images based on the command.

The audio device receives an audio playback command from the ECU 10 and plays back audio based on the command.

The braking device 40 applies braking force to the wheels. The braking device 40 includes a brake mechanism 41 (brake caliper), a brake actuator 42, and a brake ECU 43.

The brake mechanism 41 includes brake pads pressed against brake discs attached to the wheels.

The brake actuator 42 is a hydraulic actuator comprising a cylinder, piston, reservoir, oil pump, various valve devices, and a hydraulic sensor (not shown). The brake pad is connected to the tip of the piston.

When the driver presses a brake pedal (not shown) of the own vehicle (i.e., when a manual braking operation is performed), the ECU 10 sends a braking command (target braking force) corresponding to the operation manner (pedal depression depth) to the brake ECU 43.

Further, when the brake pedal is not pressed, the ECU 10 sends a predetermined braking command (target braking force) to the brake ECU 43 when a predetermined condition is met. That is, braking is automatically executed when the predetermined condition is satisfied.

The brake ECU 43 determines (calculates) the target hydraulic pressure inside the cylinder of the brake actuator 42 based on the command (target braking force) received from the ECU 10.

The brake ECU 43 controls the oil pump so that the output value of the hydraulic sensor matches the target value. In this way, the brake actuator 42 drives the brake pads. As a result, the braking force (friction force between the brake pads and the brake discs) is matched to the target value.

### (Risk Reduction Control)

The ECU 10 executes risk reduction control to reduce the risk of contact when it determines (confirms) that a pedestrian P is present in the detection area FOV and that the risk of contact between the own vehicle and the pedestrian P is high, as described below.

As described above, the camera 21 and the millimeter wave radar 22 independently detect the pedestrian P1 and pedestrian P2, respectively. However, the detection results by the camera 21 and/or the millimeter wave radar 22 may be erroneous. Therefore, the ECU 10 performs a final determination on the presence or absence of the pedestrian P based on the identity of pedestrian P1 and pedestrian P2 (similarity between the first pedestrian information and the second pedestrian information) and the continuity of the state in which both are determined to be the same, as described below.

Specifically, the ECU 10 sequentially acquires first pedestrian information from the camera 21 and second pedestrian information from the millimeter wave radar 22. Each time the ECU 10 acquires the first pedestrian information and the second pedestrian information, it determines whether the camera 21 and the millimeter wave radar 22 are detecting the same pedestrian P. The ECU 10 determines that the camera 21 and the millimeter wave radar 22 are detecting the same pedestrian P when the following condition A and condition B are both satisfied:
Condition A: The flag F1 is “1” and the flag F2 is “1”.
Condition B: The difference ΔX (=|X1−X2|) between the longitudinal distances X1 and X2 is less than or equal to threshold ΔXth, and the difference ΔY (=|Y1−Y2|) between the lateral distances Y1 and Y2 is less than or equal to threshold ΔYth.

Each time the ECU 10 acquires the first and second pedestrian information, it evaluates whether condition A and condition B are satisfied. When both conditions A and B are satisfied, it increments the count value CV of the counter CNT. The ECU 10 initializes the count value CV (CV=“0”) when a predetermined reset condition is satisfied. Specifically, the ECU 10 initializes the count value CV when the ignition switch transitions from the OFF state to the ON state (or when the risk reduction function is activated). The ECU 10 also initializes the count value CV when either or both of conditions A and B are not satisfied.

When the count value CV is greater than or equal to threshold N, the ECU 10 determines (confirms) that a pedestrian is present in the detection area FOV. That is, when the state in which the camera 21 and the millimeter wave radar 22 detect the same pedestrian P has continued for a certain period, the ECU 10 considers the detection results (F1=“1”, F2=“1”) to be accurate and adopts them as the final determination result FD.

Here, if the threshold N is relatively large, the accuracy (precision) of the final determination result FD increases, but it takes relatively longer to obtain the determination result FD. Therefore, in a scene where the pedestrian P suddenly appears in the front area FR of the own vehicle, there is a risk that the contact risk between the pedestrian P and the own vehicle may not be sufficiently reduced. Hence, the ECU 10 estimates the possibility that the pedestrian P will dart into the front area FR (i.e., cross the front area FR), and determines the value assigned to the threshold N based on the result.

When the pedestrian P suddenly changes direction of movement, the lateral acceleration ay of the pedestrian P (acceleration parallel to the width direction of the own vehicle and directed toward the vehicle) becomes relatively large. In such a case (when αy is large), the possibility that the pedestrian P will dart into the front area FR of the own vehicle is high. Therefore, the ECU 10 calculates the lateral acceleration ay of the pedestrian P and determines the value assigned to threshold N based on αy.

Specifically, each time the ECU 10 acquires second pedestrian information from the millimeter wave radar 22, it calculates the lateral acceleration αy of pedestrian P2 (a three-dimensional object potentially to be finally determined as the pedestrian P) based on that information. Concretely, the ECU 10 sequentially calculates the lateral velocity spp_y and acquires the lateral acceleration αy based on the change in spp_y (rate of change per unit time).

If the lateral acceleration αy is less than or equal to threshold αyth, the ECU 10 assigns a standard value N0 (e.g., N0=“5”) to threshold N.

On the other hand, if the lateral acceleration αy exceeds threshold αyth, the ECU 10 assigns a predetermined value N1 smaller than the standard value N0 to threshold N.

In this embodiment, as shown in FIG. 1, the scene in which a pedestrian P running parallel to the own vehicle suddenly darts into the front area FR of the own vehicle is treated as a target for advancing the timing of starting risk reduction control. Therefore, when the pedestrian P is not running parallel with the own vehicle, the ECU 10 assigns the standard value N0 to the threshold N regardless of the acceleration αy.

The ECU 10 determines that the pedestrian P is running parallel with the own vehicle when the longitudinal velocity spp_x of the pedestrian P (the velocity component parallel to the longitudinal velocity sp0_x of the own vehicle) is greater than “0” and the lateral distance Y2 is equal to or less than the threshold Y2th.

When the count value CV matches the threshold N, the ECU 10 determines whether the possibility (risk) of contact between the own vehicle and the pedestrian P is high. Specifically, based on the second pedestrian information, the ECU 10 estimates the time TTCx required for the longitudinal distance X2 between the own vehicle and the pedestrian P to become “0.” The ECU 10 obtains the value obtained by dividing the longitudinal distance X2 by the longitudinal relative velocity spr_x (=spp_x-sp0_x) as the time TTCx. Similarly, the ECU 10 estimates the time TTCy required for the lateral distance Y2 between the own vehicle and the pedestrian P to become “0.” The ECU 10 obtains the value obtained by dividing the lateral distance Y2 by the lateral relative velocity spr_y (=spp_y-sp0_y) as the time TTCy.

The ECU 10 determines that the risk of contact between the own vehicle and the pedestrian P is high when the following condition C regarding TTCx and TTCy is satisfied and condition D is also satisfied:
Condition C: The difference ΔTTC between time TTCx and time TTCy is equal to or less than a small threshold ΔTTCth.
Condition D: Both time TTCx and time TTCy are equal to or less than a threshold TTCth.

When the ECU 10 determines that the risk of contact between the own vehicle and the pedestrian P is high, it causes the notification device 30 to display a predetermined image (warning message) and to play a predetermined sound (warning sound) (alarm control). Further, the ECU 10 controls the braking device 40 so that the own vehicle is lightly braked (soft braking control).

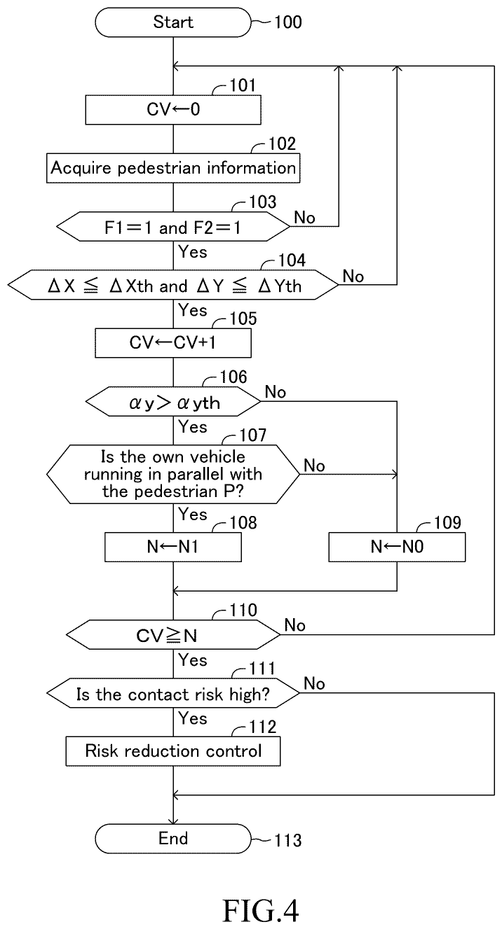

Next, with reference to FIG. 4, a description will be given of a program PR1 executed by the CPU 10a (hereinafter simply referred to as “CPU”) to realize the above-described function of the driving assistance device 1 (the function of executing risk reduction control). The CPU starts execution of the program PR1 at a predetermined cycle when the ignition switch is in the ON state.

### (Program PR1)

The CPU starts execution of the program PR1 from step 100 and proceeds to step 101.

In step 101, the CPU sets (initializes) the count value CV to “0”. Then, the CPU proceeds to step 102.

In step 102, the CPU acquires pedestrian information from the onboard sensor 20. That is, it acquires the first pedestrian information from the camera 21 and the second pedestrian information from the millimeter wave radar 22. Then, the CPU proceeds to step 103.

In step 103, the CPU determines whether “F1=1 and F2=1” (i.e., whether condition A is satisfied). If it determines that condition A is satisfied (103: Yes), it proceeds to step 104. If not (103: No), it returns to step 101.

In step 104, the CPU determines whether “ΔX≤ΔXth and ΔY≤ΔYth” (i.e., whether condition B is satisfied). If condition B is satisfied (104: Yes), it proceeds to step 105. If not (104: No), it returns to step 101.

In step 105, the CPU increments the count value CV (CV=CV+1). Then, it proceeds to step 106.

In step 106, the CPU determines whether the lateral acceleration αy of the pedestrian P exceeds the threshold αyth. If it determines that αy exceeds αyth (106: Yes), it proceeds to step 107. If not (106: No), it proceeds to step 109.

In step 107, the CPU determines whether the own vehicle and the pedestrian P are running in parallel. If it determines that they are running in parallel (107: Yes), it proceeds to step 108. If not (107: No), it proceeds to step 109.

In step 108, the CPU assigns a predetermined value N1 to the threshold N. In step 109, it assigns the standard value N0 to the threshold N. Then, the CPU proceeds to step 110.

In step 110, the CPU determines whether the count value CV is greater than or equal to the threshold N. If it is (110: Yes), the CPU proceeds to step 111. If not (110: No), it returns to step 101.

In step 111, the CPU determines whether the risk of contact between the own vehicle and the pedestrian P is high (i.e., whether both condition C and condition D are satisfied). If it determines that both conditions C and D are satisfied (111: Yes), it proceeds to step 112. If not (111: No), it proceeds to step 113 and ends the execution of program PR1.

In step 112, the CPU executes the risk reduction control. Then, it proceeds to step 113 and ends the execution of program PR1.

### Effect

When the lateral acceleration αy of a pedestrian P in the vicinity of the own vehicle is relatively large, the possibility that the pedestrian P will cross the front area FR of the own vehicle (i.e., dart into the front area FR) is high. Therefore, when the lateral acceleration αy of the pedestrian P2 (a three-dimensional object that may ultimately be determined to be pedestrian P) exceeds the threshold αyth, the driving assistance device 1 assigns a relatively small value (a predetermined value N1<N0) to the threshold count value CVth. That is, when the same pedestrian P is detected by the camera 21 and the millimeter wave radar 22, and the lateral acceleration αy is relatively large, the condition for finally determining (confirming) that the pedestrian P exists in the detection area FOV is relaxed. In other words, the timing of final determination that the pedestrian P exists in the detection area FOV is advanced compared to the normal case (where lateral acceleration αy is less than or equal to the threshold).

Then, when the risk of contact between the pedestrian and the own vehicle is high, the processor initiates the risk reduction control. Accordingly, with the driving assistance device according to the present invention, the risk of contact between the pedestrian P and the own vehicle can be efficiently reduced in a scene where the pedestrian P crosses the front area FR of the own vehicle.

### Modified Example 1

In the above embodiment, when the lateral acceleration αy of the pedestrian P running parallel to the own vehicle (acceleration relative to the road surface) exceeds the threshold αyth, the ECU 10 is configured to regard the possibility of the pedestrian P crossing the front area FR as high and to advance the timing of confirming the presence of the pedestrian P in the detection area FOV.

Alternatively, the ECU 10 may be configured to advance the timing of confirming the presence of the pedestrian P in the detection area FOV when the lateral relative acceleration αry of the pedestrian P with respect to the own vehicle exceeds the threshold.

### Modified Example 2

In the above embodiment, when the lateral acceleration αy of the pedestrian P2 (a three-dimensional object that may ultimately be determined to be pedestrian P) exceeds the threshold αyth and the pedestrian P is running parallel to the own vehicle, a relatively small value (N1) is assigned to the threshold N of the count value CV, thereby relaxing the condition for confirming the presence of the pedestrian P in the detection area FOV. Alternatively, the condition for confirming the presence of the pedestrian P in the detection area FOV may be relaxed when the lateral acceleration αy exceeds the threshold αyth, regardless of whether the pedestrian P is running parallel to the own vehicle. That is, the CPU may skip step 107 of program PR1.

### Modified Example 3

Instead of the millimeter wave radar 22, a sensor (LiDAR) that emits laser light toward the front of the own vehicle and detects an object located in front of the own vehicle based on the reflected light may be adopted.

What is claimed is:

1. A driving assistance device comprising:
a first sensor and a second sensor that output, respectively, information related to a pedestrian when the pedestrian is detected within a predetermined detection area located in front of an own vehicle; and
a processor configured to sequentially acquire the information from the first sensor and the second sensor, configured to increment a count value of a predetermined counter each time the information is acquired, when a condition for determining that the first sensor and the second sensor are detecting the same pedestrian is satisfied, and further configured to execute risk reduction control to control a predetermined device mounted on the own vehicle so as to reduce a contact risk, when the count value reaches a threshold and a condition for determining that a high risk of contact between the own vehicle and the pedestrian is satisfied, wherein the processor is configured to:
execute a first process to assign a first count value as the threshold of the count value when it is determined, based on the information, that a lateral acceleration of the pedestrian is equal to or less than a predetermined value; and
execute a second process to assign a second count value, which is smaller than the first count value, as the threshold of the count value when it is determined, based on the information, that the lateral acceleration of the pedestrian exceeds the predetermined value.

2. The driving assistance device according to claim 1,
wherein the processor is configured to be capable of executing the second process when the pedestrian and the own vehicle are traveling in the same direction and a lateral distance between the own vehicle and the pedestrian is equal to or less than a threshold.

3. The driving assistance device according to claim 1,
wherein the processor is configured to initialize the count value when a condition for determining that the first sensor and the second sensor are detecting the same pedestrian is not satisfied.

4. The driving assistance device according to claim 1,
wherein the first sensor is a camera that detects a pedestrian based on image data obtained by capturing the detection area, and
the second sensor is a radar that detects a pedestrian by emitting radio waves or laser light to the detection area and based on a distribution of reflection points.

5. The driving assistance device according to claim 1,
wherein the processor is configured to acquire a longitudinal relative speed and a lateral relative speed between the pedestrian and the own vehicle, and a longitudinal distance and a lateral distance between the pedestrian and the own vehicle,
and determine that a risk of contact between the pedestrian and the own vehicle is high when a difference between a first time obtained by dividing the longitudinal distance by the longitudinal relative speed and a second time obtained by dividing the lateral distance by the lateral relative speed is equal to or less than a threshold, and the first time and the second time are equal to or less than a threshold.
